(19) United States
(12) Patent Application Publication
(10) Pub. No.: US 2007/0160503 A1
(43) Pub. Date: Jul. 12, 2007

(54) Microfluidic systems for size based removal of red blood cells and platelets from blood

(76) Inventors: Palaniappan Sethu, Cambridge, MA (US); Mehmet Toner, Wellesley, MA (US)

Correspondence Address: CLARK & ELBING LLP, 101 FEDERAL STREET, BOSTON, MA, 02110, US

(21) Appl. No.: 10/560,662

(22) PCT Filed: Jun. 9, 2004
(86) PCT No.: PCT/US04/18373

§ 371 Date: Feb. 15, 2007

Related U.S. Application Data
(60) Provisional application No. 60/478,299, filed on Jun. 13, 2003.

(51) Int. Cl. B01L 11/00

(52) U.S. Cl. 422/101

(57) ABSTRACT

The invention features devices and methods for enriching a sample in one or more desired particles. An exemplary use of these devices and methods is for the enrichment of cells, e.g., white blood cells in a blood sample. In general, the methods of the invention employ a device that contains at least one sieve through which particles of a given size, shape, or deformability can pass. Devices of the invention have at least two outlets, and the sieve is placed such that a continuous flow of fluid can pass through the device without passing through the sieve. The devices also include a force generator for directing selected particles through the sieve. Such force generators employ, for example, diffusion, electrophoresis, dielectrophoresis, centrifugal force, or pressure-driven flow.

### STATEMENT REGARDING FEDERAL SPONSORED RESEARCH

This invention was made with Government support under Grant No. GM 62119 awarded by the NIH. The Government has certain rights in this invention.

### BACKGROUND OF THE INVENTION

The invention relates to the fields of medical diagnostics and microfluidics.

The study of disease of the blood, bone marrow, and related organs and tissues benefits from the molecular analysis of specific cells. The human body contains about five liters of blood that includes three types of cells that are found in different concentrations, red blood cells (RBCs), white blood cells (WBCs) and platelets. These cells can give insight into a variety of diseases. Disease identification may involve finding and isolating rare events, such as structural and morphological changes in specific WBCs. The first step towards this is isolation of particular cells, e.g., WBCs, from the blood sample.

There are six different types of WBCs in blood, and their concentrations are about three orders of magnitude less than the concentration of RBCs and platelets (Table 1). Initial isolation generally requires sorting devices for isolating the WBCs from the bulk of the blood sample. There are several approaches devised to separate populations of cells from blood. These cell separation techniques may be grouped into two broad categories: (1) invasive methods based on the selection of cells fixed and stained using various cell-specific markers; and (2) noninvasive methods for the isolation of living cells using a biophysical parameter specific to a population of cells of interest.

TABLE 1
Types, concentrations, and sizes of blood cells.

| | Concentration | Diameter | Surface Area | Volume | Mass Density |
|---|---|---|---|---|---|
| Cell Type | (cells/ml) | (μm) | (μm²) | (μm³) | (g/cm³) |
| Erythrocytes | 4.2-5.4 × 10⁹ | 6-9 | 120-163 | 80-100 | 1.089-1.100 |
| (red blood cells) | | | | | |
| Leukocytes | 0.4-1.1 × 10⁷ | 6-10 | 300-625 | 160-450 | 1.055-1.085 |
| (white blood cells) | | | | | |
| Neutrophils | 2-6 × 10⁶ | 8-8.6 | 422-511 | 268-333 | 1.075-1.085 |
| Eosinophils | 0.4-4.8 × 10⁵ | 8-9 | 422-560 | 268-382 | 1.075-1.085 |
| Basophils | 0-1.1 × 10⁵ | 7.7-8.5 | 391-500 | 239-321 | 1.075-1.085 |
| Lymphocytes | 1-4.8 × 10⁶ | 6.8-7.3 | 300-372 | 161-207 | 1.055-1.070 |
| Monocytes | 1-8 × 10⁵ | 9-9.5 | 534-624 | 382-449 | 1.055-1.070 |
| Thrombocytes | 2.1-5 × 10⁸ | 2-4 | 16-35 | 5-10 | 1.04-1.06 |
| (platelets) | | | | | |

Different flow cytometry and cell sorting methods are available, but these techniques typically employ large and expensive pieces of equipment, which require large volumes of sample and skilled operators. These cytometers and sorters use methods like electrostatic deflection, centrifugation [1], fluorescence activated cell sorting (FACS) [2], and magnetic activated cell sorting (MACS) [3] to achieve cell separation. The equipment to perform these assays is also commercially available. Miniaturization of cell sorting equipment using microfabrication and soft lithography techniques [4] offers the ability to fabricate cell sorting devices that are extremely efficient, easy to operate, and utilize small volumes of sample. Few attempts have been made, however, to miniaturize flow cytometers and cell sorters [5,6] that have yielded promising results which compare to the larger macroscale devices.

Since the prior art methods suffer from high cost and need for skilled operators and large sample volumes, there is a need for new devices and methods for enriching a particular type of cell in a mixture that overcomes these limitations.

### SUMMARY OF THE INVENTION

The invention features devices and methods for enriching a sample in one or more desired particles. An exemplary use of these devices and methods is for the enrichment of cells, e.g., white blood cells in a blood sample. In general, the methods of the invention employ a device that contains at least one sieve through which particles of a given size, shape, or deformability can pass. Devices of the invention have at least two outlets, and the sieve is placed such that a continuous flow of fluid can pass through the device without passing through the sieve. The devices also include a force generator for directing selected particles through the sieve. Such force generators employ, for example, diffusion, electrophoresis, dielectrophoresis, centrifugal force, or pressure-driven flow.

In one aspect, the invention features a device for concentrating particles. The device includes a channel having an inlet and first and second outlets; a first sieve disposed between the inlet and the first outlet, wherein the first sieve is not disposed between the inlet and the second outlet; and a force generator to direct particles to the first sieve. The force generator may produce a greater flow rate through the first outlet than the second outlet. The sieve may also be disposed in a region of the channel, and the force generator may include a channel widening at a point in the region containing the sieve such that fluid entering the region is drawn through the sieve. The device may further include a third outlet and a second sieve disposed between the inlet and the third outlet, wherein the sieves are disposed in a region of the channel, and wherein the force generator includes a channel widening at a point in the region containing the sieves such that fluid entering the region is drawn through the sieves. The force generator includes, for example, two electrodes, wherein the first sieve is disposed between the electrodes such that, when a DC voltage is applied to the electrodes, charged particles are capable of being moved to or away from the first sieve by electrophoresis. In another embodiment, the force generator includes two or more electrodes capable of producing a non-uniform electric field such that particles are capable of being moved to or away from the first sieve by dielectrophoresis. Alternatively, the force generator includes a curved channel, such that particles are capable of being moved to the first sieve by centrifugal force. Preferably, the pressure drop along the length of the sieve in the direction of flow between the inlet and the second outlet is substantially constant. An exemplary sieve allows passage of maternal red blood cells but not fetal red blood cells.

The device of the invention is used in a method of producing, from a fluid containing particles, a sample enriched in a target population of particles. This method includes the steps of providing a device of the invention; directing the fluid containing particles through the inlet into the channel; actuating the force generator, as described herein, so that particles in the fluid are directed to the first sieve and do or do not substantially pass through the first sieve based on the size, shape, or deformability of the particles; and collecting the effluent containing particles of the target population from the first outlet if the particles of the target population substantially pass through the first sieve or from the second outlet if the particles of the target population do not substantially pass through the first sieve, thereby producing the sample enriched in the target population of particles. Exemplary target populations include fetal red blood cells, cancer cells, and infectious organisms.

By “particle” is meant any solid object not dissolved in a fluid. Particles can be of any shape or size. Exemplary particles are cells and beads.

By “force generator” is meant any device that is capable of applying a force on a particle in a fluid. A force generator may be a device coupled to a channel or may be a part of a channel. Exemplary force generators include, for example, electrodes for electrophoresis or dielectrophoresis, a channel widening (e.g., a, diffuser as described herein), and a curved channel coupled with a pressure source.

By “microfluidic” is meant having at least one dimension of less than 1 mm.

Other features and advantages of the invention will be apparent from the following detailed description and the claims.

### BRIEF DESCRIPTION OF THE DRAWINGS

FIG. 1 is an illustration of different geometries for sieves of the invention.

FIG. 2 is a schematic diagram of a device employing differential flow rates at two outputs.

FIG. 3 is a schematic diagram of a low shear stress diffuser device of the invention. Design parameters for separating RBCs are also shown.

FIG. 4 is schematic depiction of laminar flow streamlines when fluid moves through a diffuser device of the invention.

FIG. 5 is a simple resistor model to calculate pressure drop across the sieves.

FIG. 6 is a graph of the calculated pressure drop across the sieves along the length of the device.

FIG. 7 is a model used to ensure uniform pressure drop across the sieves.

FIG. 8 is a schematic diagram of a device having substantially uniform pressure drop across a sieve.

FIG. 9 is a schematic diagram of a device of the invention employing electrophoresis to manipulate particles in the channel.

FIG. 10 is a schematic diagram of the separation of particles by dielectrophoresis using an asymmetric AC field.

FIG. 11 is a schematic diagram of a device employing centrifugal force to separate particles of different sizes.

FIG. 12 is a schematic diagram of a device employing bidirectional flow.

FIG. 13 is a low magnification micrograph of a channel structure having a diffuser geometry and two sieves.

FIG. 14 is a high magnification micrograph showing the 5 micron gaps between the sieves in the device of FIG. 13.

FIG. 15 is a micrograph of a device for electrophoretic manipulation of particles.

### DETAILED DESCRIPTION OF THE INVENTION

The invention features a device for concentrating particles in a fluid, e.g., enriching a sample in white blood cells. In general, the device of the invention includes a channel having an inlet and two or more outlets, and one or more sieves is disposed between an inlet and an outlet in the channel. When a fluid containing particles passes through the device, particles of a desired size, shape, or deformability may pass through the sieve, while other particles do not The devices employ a force generator to direct particles through a sieve.

The following discussion will focus on the enrichment of white blood cells (WBCs) from red blood cells (RBCs) and platelets in a blood sample. The devices and methods of the invention are, however, generally applicable to any mixture of particles having different size, shape, or deformability. The devices of the invention may also be used to remove excess fluid from a sample of particles without the separation of any particles, for example, by employing a sieve having pores smaller than all particles in the sample.

Device

Separation of particles in a device of the invention is based on the use of sieves that selectively allow passage of particles based on their size, shape, or deformability.

The size, shape, or deformability of the pores in the sieve determines the types of particles that can pass through the sieve.

Two or more sieves can be arranged in series or parallel, e.g., to remove cells of increasing size successively.

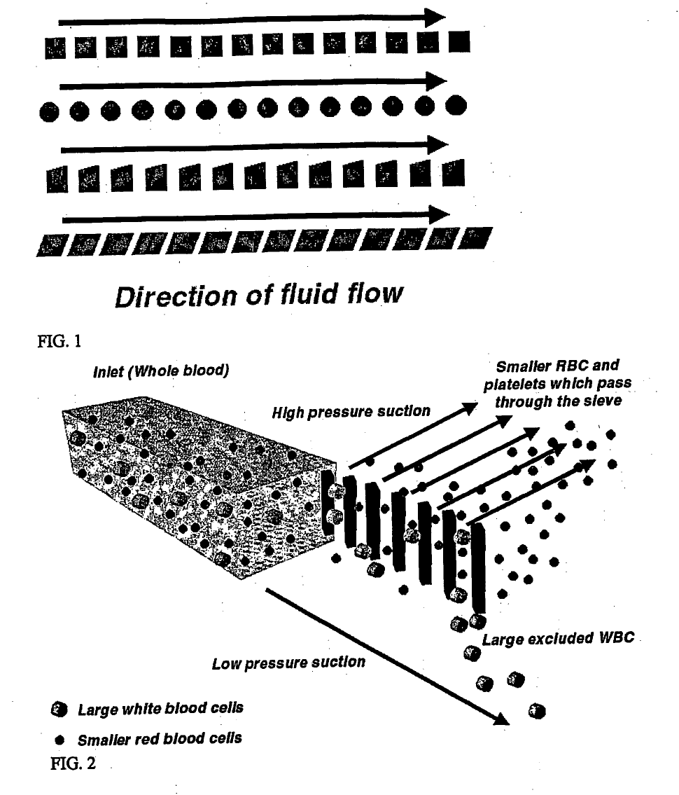

In one embodiment, the sieve includes a series of posts that are spaced apart. A variety of post sizes, geometries, and arrangements can be used in devices of the invention. FIG. 1 illustrates different shapes of posts that can be used in a sieve. The gap size between the posts and the shape of the posts may be optimized to ensure fast and efficient filtration. For example, the size range of the RBCs is on the order of 5-8 μm, and the size range of platelets is on the order of 1-3 μm. The size of all WBCs is greater than 10 μm. In addition, fetal RBCs can be separated from maternal red blood cells based on size, as the spacing in a sieve can be designed to allow passage of the maternal RBCs but not the nucleated fetal RBCs. Large gaps between posts increase the rate at which the RBCs and the platelets pass through the sieve, but increased gap size also increases the risk of losing WBCs. Smaller gap sizes ensure more efficient capture of WBCs but also a slower rate of passage for the RBCs and platelets. Depending on the type of application different geometries can be used.

Sieves may be manufactured by other methods. For example, a sieve could be formed by molding, electroforming, etching, drilling, or otherwise creating holes in a sheet of material, e.g., silicon, nickel, or PDMS. Alternatively, a polymer matrix or inorganic matrix (e.g., zeolite or ceramic) having appropriate pore size could be employed as a sieve in the devices described herein.

One problem associated with devices of the invention is clogging of the sieves. This problem can be reduced by appropriate sieve shapes and designs and also by treating the sieves with non-stick coatings such as bovine serum albumin (BSA) or polyethylene glycol (PEG). One method of preventing clogging is to minimize the area of contact between the sieve and the particles.

The device of the invention is a particle sorter, e.g., that filters larger WBCs from blood, that typically operates in a continuous flow regime. The location of the sieves in the device is chosen to ensure that the maximum number of particles come into contact with the sieves, while at the same time avoiding clog gig and allowing for retrieval of the particles after separation. In general, particles are moved across their laminar flow lines which are maintained because of extremely low Reynolds number in the channels in the device, which are typically microfluidic. Several different designs of a blood cell sorter are described that involve different mechanisms (pressure driven flow, electrophoresis, dielectrophoresis, and centrifugal force) to move particles across the laminar flow lines and to come into contact with the sieves. Devices employing each of these schemes are described below.

Pressure Driven Flow

Variable Outlet Pressure. The schematic diagram of a device based on differences in pressure at two outlets is shown in FIG. 2. In this device, the flow rate through outlet 1 is greater than the flow rate through outlet 2. This configuration allows the particles to move across their laminar flow lines and come in contact with a sieve between the outlet 1 and the main channel. Particles that cannot pass through a sieve are subject to flow to outlet 2 and continue moving in the device, reducing or eliminating clogging of the sieve. The pressure difference between the two outlets can be achieved through any appropriate means. For example, the pressure may be controlled using external syringe pumps or by designing outlet 1 to be larger in size than outlet 2, thereby reducing the fluidic resistance of outlet 1 relative to outlet 2.

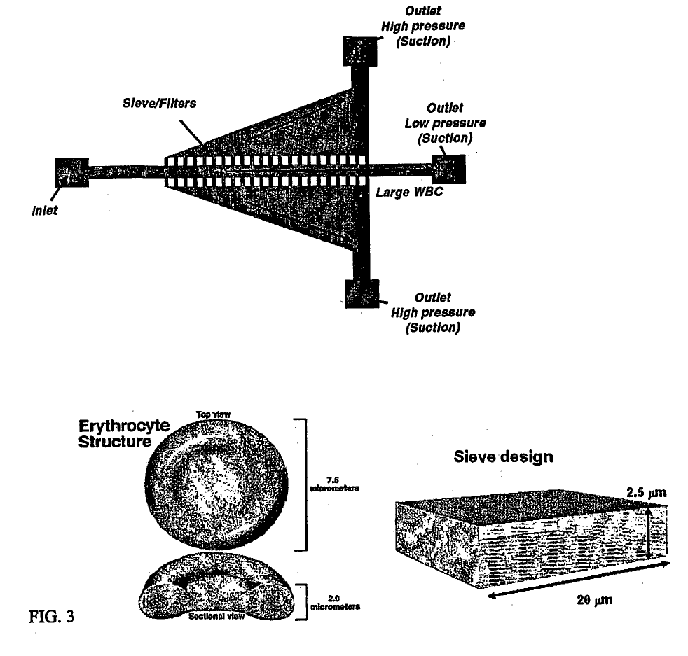

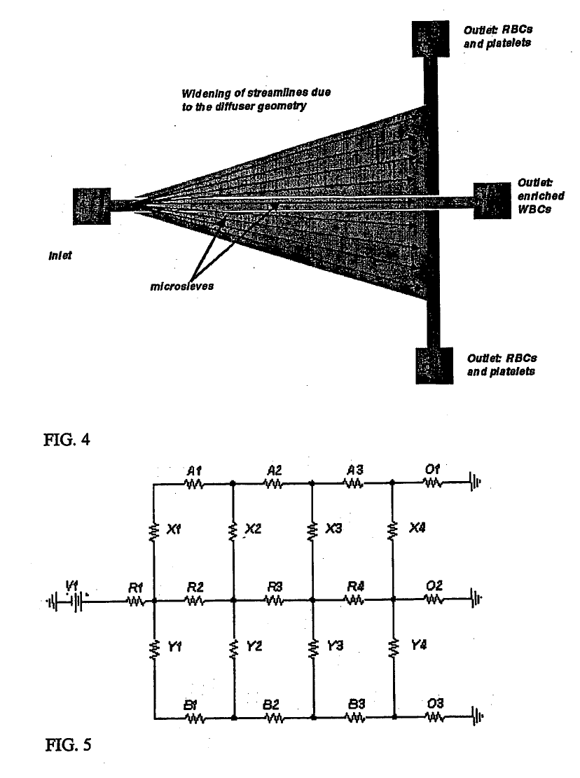

Diffuser. The schematic diagram of a low shear stress filtration device is shown in FIG. 3. The device has one inlet channel which leads into a diffuser, which is a widened portion of the channel. In one configuration, the channel widens in a V-shaped pattern. The diffuser contains two sieves having pores shaped to filter smaller RBCs and platelets from blood, while enriching the population of WBCs. The diffuser geometry widens the laminar flow streamlines forcing more cells to come in contact with the sieves while moving through the device (FIG. 4). The device contains 3 outlets, two outlets that collect cells that pass through the sieves, e.g., the RBCs and platelets, and one outlet that collects the enriched WBCs.

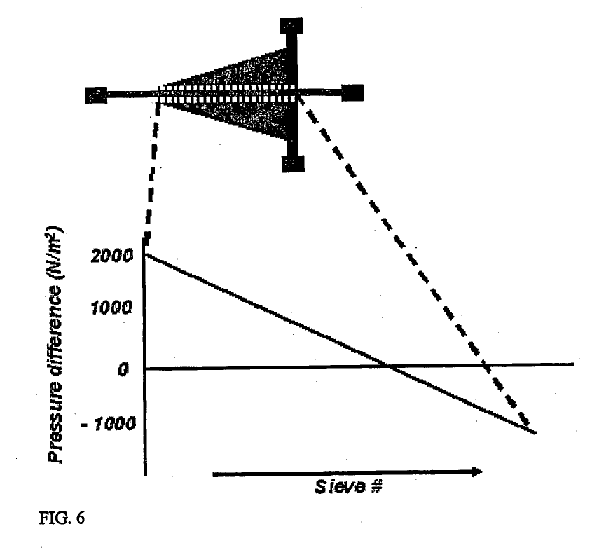

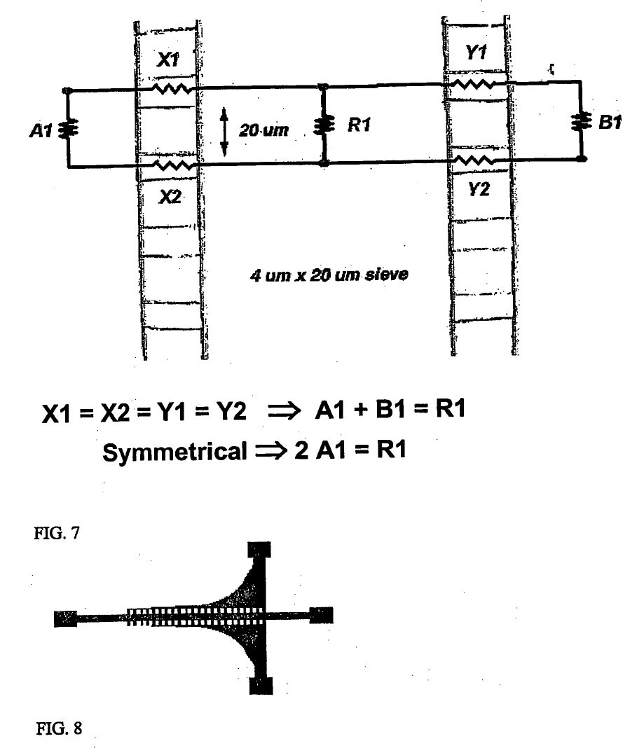

The pressure-difference across individual sieves relative to the length of the device in FIG. 3 was modeled using a simple resistor model (FIG. 5). In this model, the pressure difference drops linearly along the sieve, and, towards the end of the sieve, a negative pressure drop is present which can cause back flow through the sieve potentially reducing separation yield (FIG. 6). The configuration of the device of FIG. 3 thus results in a reduced percentage of the sieve operating under the desired conditions. The initial portion of the sieve subjects the cells to a much larger pressure drop than the latter portion of the sieve, which has a small or even a negative pressure drop. This difference in pressure drop along a sieve can be addressed by altering the shape of the diffuser using the same resistor model (FIG. 7) to ensure a more uniform pressure drop across the sieve. A configuration resulting in a uniform pressure drop along a sieve is shown in FIG. 8.

The diffuser device typically does not ensure 100% depletion of RBCs and platelets. Initial RBC:WBC ratios of 600:1 can, however, be improved to ratios around 1:1. Advantages of this device are that the flow rates are low enough that shear stress on the cells does not affect the phenotype or viability of the WBCs and that the filters ensure that all the WBCs are retained such that the loss of WBCs is minimized or eliminated. Widening the diffuser angle will result in a larger enrichment factor. Greater enrichment can also be obtained by the serial arrangement of more than one diffuser where the outlet from one diffuser feeds into the inlet of a second diffuser. Widening the gaps between the posts might expedite the depletion process at the risk of losing WBCs through the larger pores in the sieves.

Electrophoresis:

Electrophoresis involves manipulation of charged particles by applying a DC voltage between two electrodes. The charged particles tend to move towards the oppositely charged electrodes. Cells are typically negatively charged at normal pH levels and migrate towards the positive electrode during electrophoresis [7]. Electrophoresis across the width of a channel can be used to drive particles out of the flow lines to come into contact with a sieve, while flow along the length of the channel can be maintained to achieve continuous flow separation and avoid clogging of the sieves. Typically blood cells move at rates of about 1 μm/sec at applied voltages of 1 V/cm, which is sufficient to move particles such as cells across the width of a channel within a reasonable length of time. This voltage level also avoids bubble formation or adverse effects to the cells.

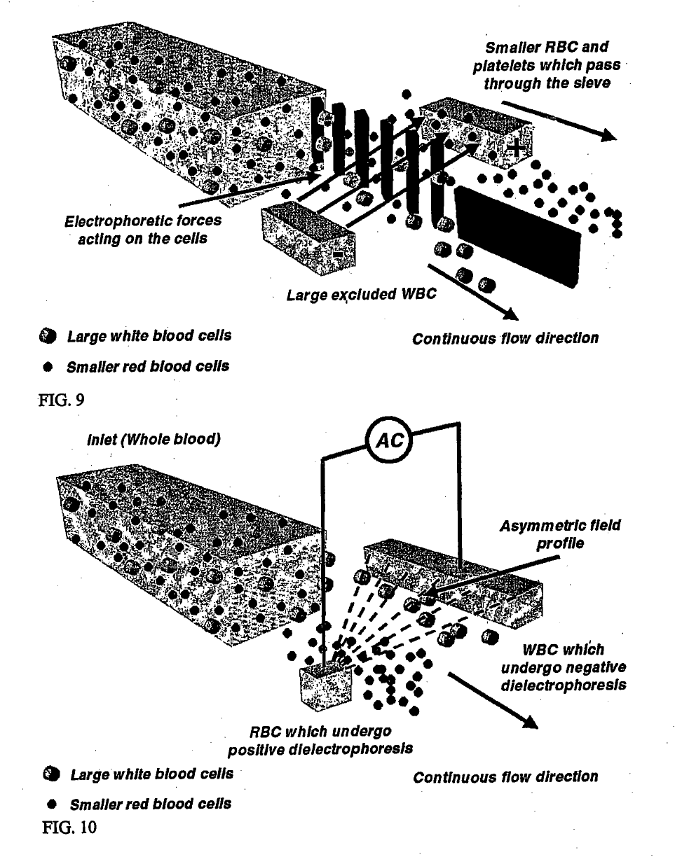

A schematic for an electrophoresis device is shown in FIG. 9. In this device, the sieve is located between two electrodes. When a DC voltage is applied to the electrodes, negatively charged cells are directed to the sieve, but only RBCs and platelets can pass through the sieve.

Dielectrophoresis:

Dielectrophoresis is the application of an asymmetric AC field at high frequencies to manipulate particles, e.g., cells. Depending on the polarizability of the medium and the cells, the cells undergo either positive (towards the high field) or negative (away from the high field) dielectrophoresis [8,9]. The motion of different cells in different directions (positive or negative dielectrophoresis) can be tuned by varying the frequency. It has been shown at lower frequencies that RBCs undergo negative dielectrophoresis and at higher frequencies undergo positive dielectrophoresis [10]. Dielectrophoresis again can be used to move different cells in different directions across their laminar flow lines to create separation or bring them in contact with the sieve while maintaining continuous flow.

Dielectrophoresis can be used to move WBCs, RBCs, and platelets or only RBCs and platelets to the sieves. A schematic depiction of the separation of cells using dielectrophoresis is shown in FIG. 10. By placing a sieve between the two electrodes, size, shape, or deformability based separation of particles occurs.

In an alternative embodiment, dielectrophoresis could be used to separate two or more populations of cells spatially without the use of a sieve. The two populations of cells cold then be directed into different outlets and collected

Centrifugal Force Based Separation:

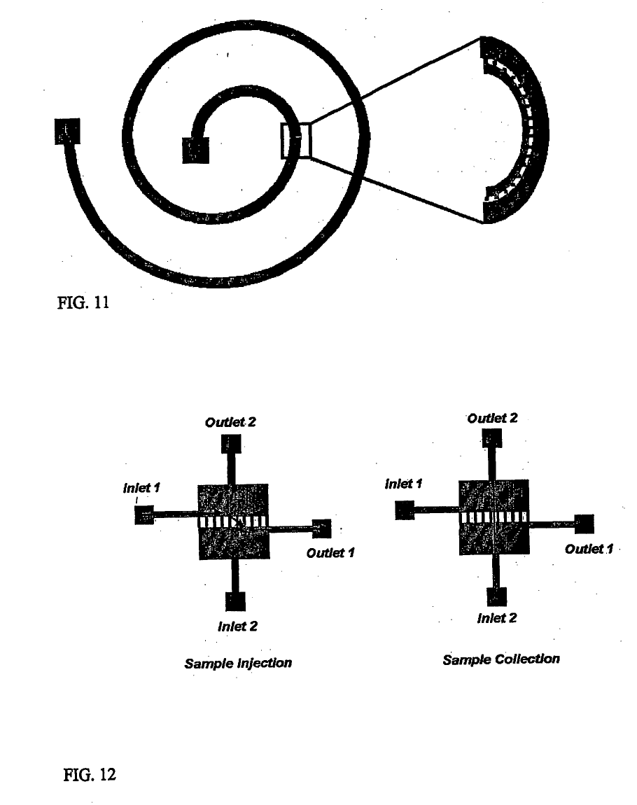

Another technique that can be used to separate cells of different masses (sizes) is the use of centrifugal force acting on a curved channel. The centrifugal force acting on a particle is given by F=mω²X where, m=mass of the particle, ω=angular velocity of the spinning rotor, in radians per second, X=distance of the particle from the axis of rotation (or radius of rotor). As the mass and velocity of flow increases, the centrifugal force acting on the particles also increases. By designing a spiral structure as shown in FIG. 11 and by controlling the flow rate (speed of particles) using, e.g., an external syringe pump, particles of different sizes can be separated with smaller particles being filtered using a sieve that partitions the channel. In a blood sample, the smaller RBCs and platelets pass through the sieve, and the larger WBCs do not, thus achieving separation and enrichment of WBCs.

Bi-Directional Flow:

Another technique for separation of particles is the use of directional flow that can be controlled, e.g., by external syringe pumps. The principle is illustrated in FIG. 12. Initial flow of the sample is from inlet 1 to outlet 1 where the sample passes through sieves, and the larger particles are excluded. After the entire sample volume is filtered, a buffer (inlet 2) is used to flush the excluded particles from the sieves, which are collected through outlet 2.

Variations

Devices of the invention may be designed to contain more than two outlets and more than one sieve in order to create more than two populations of particles. Such multiple pathways may be arranged in series or parallel. For example, in an electrophoretic device multiple sieves can be placed between the electrodes to create a plurality of chambers. The sieve nearest the inlet has the largest pores, and each successive sieve has smaller pores to separate the population into multiple fractions. Similar devices are possible using dielectrophoresis, pressure driven flow, and centrifugal flow.

Fabrication

Simple microfabrication techniques like poly(dimethylsiloxane) (PDMS) soft lithography, polymer casting (e.g., using epoxies, acrylics, or urethanes), injection molding, polymer hot embossing, laser micromachining, thin film surface micromachining, deep etching of both glass and silicon, electroforming, and 3-D fabrication techniques such as stereolithography can be used for the fabrication of the channels and sieves of devices of the invention. Electrodes may be fabricated by standard techniques, such a lift off, evaporation, molding, or other deposition techniques. Most of the above listed processes use photomasks for replication of micro-features. For feature sizes of greater than 5 μm, transparency based emulsion masks can be used. Feature sizes between 2 and 5 μm may require glass based chrome photomasks. For smaller features, a glass based E-beam direct write mask can be used. The masks are then used to either define a pattern of photoresist for etching in the case of silicon or glass or define negative replicas, e.g., using SU-8 photoresist, which can then be used as a master for replica molding of polymeric materials like PDMS, epoxies, and acrylics. The fabricated channels and may then be bonded onto a rigid substrate like glass to complete the device. Other methods for fabrication are known in the art A device of the invention may be fabricated from a single material or a combination of materials.

Methods

Devices of the invention can be employed in methods to separate or enrich a population of particles in a mixture or suspension. Preferably, methods of the invention remove at least 50%, 60%, 70%, 80%, 90%, 95%, or 99% of the undesirable particles from a sample. In the methods of the invention, samples are introduced into a device of the invention. Once introduced into the device, desired cells are separated from the bulk sample, either by passing through a sieve or by not passing through the sieve. Cells are directed to (or away from) the sieve by an external force, e.g., generated by pressure driven flow, electric fields, or centrifugal forces. The devices of the invention have at least two outlets, where, to reach one outlet, cells must pass through the sieve. Once separated, particles can be collected, e.g., for further purification, analysis, storage, modification, or culturing.

Although generally described as being useful for separating WBCs from blood. The methods of the invention may be employed to separate other cells or particles. For example, the device may be used to isolate cells from normally sterile bodily fluids, such as urine or spinal fluid. In other embodiments, rare cells may be isolated from samples, e.g., fetal red blood cells from maternal blood, cancer cells from blood or other fluids, and infectious organisms from animal or environmental samples. Devices of the invention may therefore be used in the fields of medical diagnostics, environmental or quality assurance testing, combinatorial chemistry, or basic research.

The following examples are intended to illustrate various features of the invention and are not intended to be limiting in any way.

### EXAMPLE 1

### Diffusive Filter

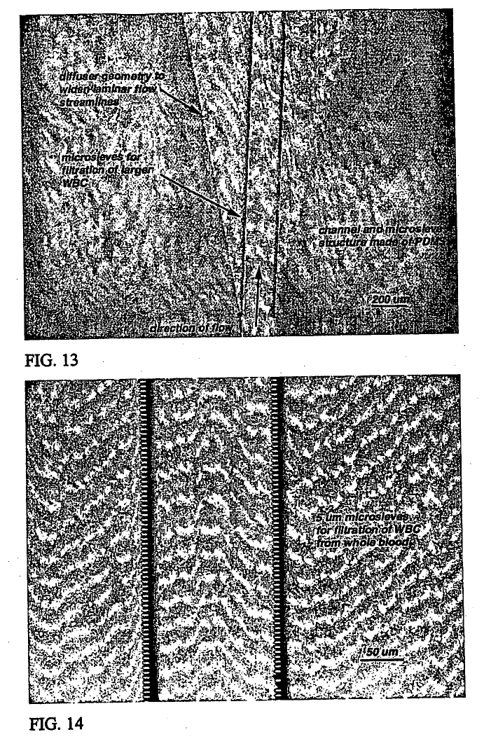

A device for size based separation of smaller RBCs and platelets from the larger WBCs was fabricated using simple soft lithography techniques (FIG. 13). A chrome photomask having the features and geometry of the device was fabricated and used to pattern a silicon wafer with a negative replica of the device in SU-8 photoresist This master was then used to fabricate PDMS channel and sieve structures using standard replica molding techniques. The PDMS device was bonded to a glass slide after treatment with O₂ plasma. FIG. 13 shows a low magnification image of the channel structure with the diffuser geometry and sieves. The diffuser geometry is used to widen the laminar flow streamlines to ensure that the majority of the particles or cells flowing through the device will interact with the sieves. The smaller RBC and platelets pass through the sieves, and the larger WBCs are confined to the central channel. A higher magnification picture of the sieves is shown in FIG. 14.

### EXAMPLE 2

### Electrophoresis

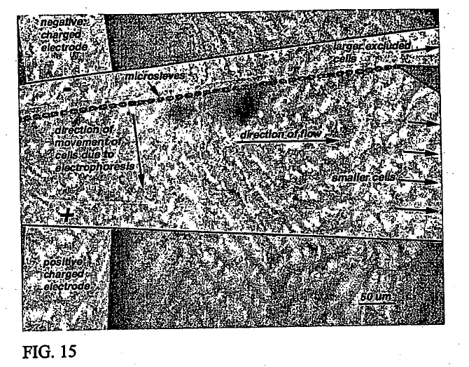

Electrophoresis can also be used to move cells across their laminar flow streamlines and ensure that all the cells or particles interact or come in contact with the sieves. The device was fabricated as in Example 1, but the PDMS is bonded to a glass slide having gold electrodes that were patterned photolithographically (FIG. 15). Electrophoresis is used to attract negatively charged cells towards the positively charged electrode. The smaller RBC and platelets pass through the sieves, while the larger WBCs are excluded. The WBCs are isolated and extracted through a separate port

### REFERENCES

1. J. Bauer, “Advances in cell separation: recent developments in counter flow centrifugal elutriation and continuous flow cell separation”, Journal of Chromatography B, 722, pp 55-69, 1999.

2. M. T. Anderson, I. M. Tjioe, M. C. Lorincz, D. R. Parks, L. A. Herzenberg, G. P. Nolan and L. A. Herzenberg, “Simultaneous fluorescence-activated cell sorter analysis of two distinct transcriptional elements within a single cell using engineered green fluorescent proteins”, Proc. Natl. Acad. Sci. USA Vol. 93, pp. 8508-8511, August 1996.

3. L. R. Moore, M. Zborowski, L. Sun, J. J. Chalmers, Lymphocyte fractionation using immunomagnetic colloid and dipole magnetic flow cell sorter. J Biochemistry and Biophysics Methods 1998.

4. E. Kim, Y. Xia, and G. M. Whitesides, “Polymer microstructures formed by molding in capillaries,” Nature, vol. 376, p. 347, 1996.

5. A. Y. Pu, H. P. Chou, C. Spence, F. H. Arnold and S. K Quake, “An Integrated Microfabricated Cell Sorter,” Anal. Chem. (2002).

6. Dongeun Huh, Hsien-Hung Wei, Oliver D. Kripfgans, J. Brian Fowlkes, James B. Grotberg, Shuichi Takayama, “Gravity-Driven Microhydrodynamics-Based Cell Sorter (microHYCS) for Rapid, Inexpensive, and Efficient Cell Separation and Size-Profiling,” IEEEE-EMBS, 2002.

7. J. Mehrishi and J. Bauer, “Electrophoresis of Cells and the biological relevance of surface charge,” Electrophoresis, 23, pp. 1984-1994, 2002.

8. S. Archer, T. T. Li, A. T. Evans, S. T. Britland and H. Morgan, “Cell reactions to Dielectrophoretic Manipulation,” Biochem. Biophys. Res. Comm., 257, 687-698, 1999.

9. J. Voldman, R. A. Braff, M. Toner, M. L. Gray and M. A. Schmidt, “Holding forces of Single-particle Dielectrophoretic Traps,” Biophys. J., 80, pp. 531-541, 2001.

10. C. Xu, Y. Wang, M. Cao and Z. Lu, “Dielectrophoresis of human red cells in microchips,” Electrophoresis, 20, pp. 1829-1831, 1999.

### Other Embodiments

All publications, patents, and patent applications mentioned in the above specification are hereby incorporated by reference. Various modifications and variations of the described method and system of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the art are intended to be within the scope of the invention.

Other embodiments are in the claims.

What is claimed is:

1. A device for concentrating particles, the device comprising:
a. a channel having an inlet and first and second outlets;
b. a first sieve disposed between the inlet and the first outlet, wherein the first sieve is not disposed between the inlet and the second outlet; and
c. a force generator to direct particles to the first sieve.

2. The device of claim 1, wherein the force generator produces a greater flow rate through the first outlet than the second outlet.

3. The device of claim 1, wherein the sieve is disposed in a region of the channel, and wherein the force generator comprises a channel widening at a point in the region containing the sieve such that fluid entering the region is drawn through the sieve.

4. The device of claim 3, wherein the pressure drop along the length of the sieve in the direction of flow between the inlet and the second outlet is substantially constant.

5. The device of claim 1, further comprising a third outlet and a second sieve disposed between the inlet and the third outlet, wherein the sieves are disposed in a region of the channel, and wherein the force generator comprises a channel widening at a point in the region containing the sieves such that fluid entering the region is drawn through the sieves.

6. The device of claim 5, wherein the pressure drop along the length of the sieves in the direction of flow between the inlet and the second outlet is substantially constant.

7. The device of claim 1, wherein the force generator comprises two electrodes, wherein the first sieve is disposed between the electrodes such that, when a DC voltage is applied to the electrodes, charged particles are capable of being moved to or away from the first sieve by electrophoresis.

8. The device of claim 1, wherein the force generator comprises two or more electrodes capable of producing a non-uniform electric field such that particles are capable of being moved to-or away from the first sieve by dielectrophoresis.

9. The device of claim 1, wherein the force generator comprises a curved channel, such that particles are capable of being moved to the first sieve by centrifugal force.

10. The device of claim 1, wherein the first sieve allows passage of maternal red blood cells but not fetal red blood cells.

11. A method of producing, from a particle-containing fluid, a sample enriched in a target population of particles, the method comprising the steps of:
a. providing a device comprising:
i. a channel having an inlet and a first and a second outlet; and
ii. a first sieve disposed between the inlet and the first outlet, wherein the first sieve is not disposed between the inlet and the second outlet; and
iii. a force generator to direct particles to the first sieve;
b. directing the particle-containing fluid through the inlet into the channel;
c. actuating the force generator so that particles in the fluid are directed to the first sieve and do or do not substantially pass through the first sieve based on the size, shape, or deformability of the particles; and
d. collecting the effluent containing particles of the target population from the first outlet if the particles of the target population substantially pass through the first sieve or from the second outlet if the particles of the target population do not substantially pass through the first sieve, thereby producing the sample enriched in the target population of particles.

12. The method of claim 11, wherein said force generator produces a greater flow rate through the first outlet than the second outlet.

13. The method of claim 11, wherein the sieve is disposed in a region of the channel, and wherein the force generator comprises a channel widening at a point in the region containing the sieve such that fluid entering the region is drawn through the sieve.

14. The method of claim 13, wherein the pressure drop along the length of the sieve in the direction of flow between the inlet and the second outlet is substantially constant.

15. The method of claim 11, wherein the device further comprises a third outlet and a second sieve disposed between the inlet and the third outlet, wherein the sieves are disposed in a region of the channel, and wherein the force generator comprises a channel widening at a point in the region containing the sieves such that fluid entering the region is drawn through the sieves.

16. The method of claim 15, wherein the pressure drop along the length of the sieves in the direction of flow between the inlet and the second outlet is substantially constant.

17. The method of claim 11, wherein the device further comprises a third outlet and a second sieve disposed between the inlet and the third outlet, wherein the sieves are disposed in a region of the channel, and wherein the force generator comprises a channel widening at a point in the region containing the sieves such that fluid entering the region is drawn through the sieves.

18. The method of claim 11, wherein the force generator comprises two electrodes, wherein the first sieve is disposed between the electrodes such that, when a DC voltage is applied to the electrodes, charged particles are capable of being moved to or away from the first sieve by electrophoresis.

19. The method of claim 11, wherein the force generator comprises electrodes capable of producing a non-uniform electric field such that particles are capable of being moved to or away from the first sieve by dielectrophoresis.

20. The method of claim 11, wherein the force generator comprises a curved channel, such that particles are capable of being moved to the first sieve by centrifugal force.

21. The method of claim 11, wherein said target population comprises fetal red blood cells.

22. A device for enriching a first cell type from a blood sample comprising a first inlet in communication with a channel wherein said channel comprises two rows of obstacles that direct said first cell type in a first direction and a second cell type in a second direction, and wherein said device comprises a first outlet in said first direction and a second outlet in said second direction.

23. The device of claim 22 wherein said first cell type is a fetal red blood cell.

24. The device of claim 22 wherein said first cell type is a cancer cell.

25. The device of claim 22 wherein said second cell type is an enucleated red blood cell or a platelet.

26. The device of claim 22 wherein said first cell type is larger than said second cell type.

27. The device of claim 22 wherein at least 90% of said first cell type in said blood sample is directed in said first direction.

28. The device of claim 22 wherein at least 95% of said first cell type in said blood sample is directed in said first direction.

29. The device of claim 22 wherein said two rows of obstacles are in parallel.

30. The device of claim 22 wherein said device comprises a polymer.

31. The device of claim 22 wherein said two rows of obstacles direct said first cell type in said first direction and a third direction, wherein said device further comprises a third outlet in said third direction.

32. The device of claim 22 wherein said channel is coupled to a pressure generator.

33. The device of claim 32 wherein said pressure generator generates hydrodynamic pressure.

34. The device of claim 32 wherein said pressure generator generates a centrifugal force.

35. The device of claim 32 wherein said pressure generator maintains a first pressure between said first inlet and said first outlet and a second pressure between said first inlet and said second outlet.

36. The device of claim 35 wherein said first pressure is less than said second pressure.

37. The device of claim 32 wherein said pressure generator generates a uniform pressure drop across one of said rows of obstacles.

38. The device of claim 22 wherein said device further comprises a second inlet in communication with said channel.

39. A device for enriching a first cell type from a fluid sample comprising said first cell type and a second cell type, said device comprising:
a first inlet fluidly coupled to a channel comprising a plurality of obstacles that direct said first cell type in a first direction and said second cell type in a second direction, wherein said first cell type is a cancer cell or a fetal red blood cell and wherein said device further comprises a first outlet in said first direction and a second outlet in said second direction.

40. The device of claim 39 wherein said second cell type is an enucleated red blood cell or a platelet.

41. The device of claim 39 wherein at least 95% of said second cell type is directed in said second direction.

42. The device of claim 39 further comprising a second plurality of obstacles positioned in series or in parallel to said first plurality of obstacles.

43. The device of claim 22 wherein said second plurality of obstacles is positioned in series to said first plurality of obstacles and wherein the obstacles in said second plurality of obstacles are spaced apart at a smaller distance than the obstacles in said first plurality of obstacles.

44. The device of claim 39 wherein said device comprises a polymer.

45. The device of claim 39 wherein said channel is wider at a point adjacent said plurality of obstacles compared to a point adjacent said inlet.

46. The device of claim 39 wherein said channel is coupled to a pressure generator.

47. The device of claim 46 wherein said pressure generator generates hydrodynamic pressure.

48. The device of claim 46 wherein said pressure generator provides centrifugal force.

49. The device of claim 46 wherein said pressure generator maintains a first pressure between said first inlet and said first outlet and a second pressure between said first inlet and said second outlet.

50. The device of claim 49 wherein said first pressure is less than said second pressure.

51. The device of claim 39 wherein pressure drop across said plurality of obstacles is uniform.

52. The device of claim 39 wherein said device further comprises a second inlet in communication with said channel.

53. A method for enriching one or more fetal red blood cells in a fluid sample comprising fetal red blood cells and non-fetal red blood cells, said method comprising: applying said fluid sample to a device comprising a first inlet coupled to a channel comprising a plurality of obstacles that directs said one or more fetal red blood cells in a first direction and said one or more non-fetal red blood cells in a second direction, wherein said device further comprises a first outlet in said first direction and a second outlet in said second direction.

54. The method of claim 53 wherein said non-fetal red blood cell is a red blood cell or a platelet.

55. The method of claim 53 wherein said fluid sample is a maternal blood sample.

56. The method of claim 53 further comprising applying a centrifugal force to said sample.

57. A method for enriching one or more cancer cells from a fluid sample comprising cancer cells and non-cancer cells, said method comprising: applying said fluid sample to a device comprising a first inlet coupled to a channel comprising a plurality of obstacles that directs said one or more cancer cells in a first direction and one or more non-cancer cells in a second direction, wherein said device further comprises a first outlet in said first direction and a second outlet in said second direction.

58. The method of claim 57 wherein said non-cancer cell is a red blood cell or a platelet.

59. The method of claim 57 wherein said fluid sample is a blood sample.

60. The method of claim 57 further comprising applying a centrifugal force to said sample.

61. A method for enriching a first cell type from a blood sample comprising said first cell type and a second cell type, said method comprising: applying said blood sample to a device comprising a first inlet adapted for delivering said blood sample to a channel wherein said channel comprises two rows of obstacles that direct said first cell type in a first direction and a second cell type in a second direction, and wherein said device comprises a first outlet in said first direction and a second outlet in said second direction.

62. The method of claim 61 wherein said obstacles are separated from one another by a microfluidic gap.

63. The method of claim 61 wherein said first cell type is a nucleated cell and said second cell type is an enucleated cell.
